(19) United States
(12) Patent Application Publication
(10) Pub. No.: US 2025/0084191 A1
(43) Pub. Date: Mar. 13, 2025

(54) FLUORINE RESIN REFINING METHOD, METHOD FOR PRODUCING REFINED FLUORINE RESIN, FLUORINE RESIN, OPTICAL MATERIAL, ELECTRONIC MATERIAL AND PLASTIC OPTICAL FIBER

(71) Applicant: NITTO DENKO CORPORATION, Ibaraki-shi, Osaka (JP)

(72) Inventors: Yoshihide KAWAGUCHI, Osaka (JP); Takashi SHIMIZU, Osaka (JP); Takeshi SAITO, Osaka (JP); Akifumi KIDO, Osaka (JP)

(73) Assignee: NITTO DENKO CORPORATION, Ibaraki-shi, Osaka (JP)

(21) Appl. No.: 18/726,943

(22) PCT Filed: Jan. 10, 2023
(86) PCT No.: PCT/JP2023/000344

§ 371 Date: Jul. 5, 2024

(30) Foreign Application Priority Data
Jan. 11, 2022 (JP) 2022-002622

(51) Int. Cl. C08F 8/00; C08F 24/00; G02B 6/02

(52) U.S. Cl. CPC C08F 8/00; C08F 24/00; G02B 6/02

(57) ABSTRACT

One aspect of the present invention is a fluorine resin refining method. The method includes refining a fluorine resin by bringing the fluorine resin into contact with a fluorinating agent at a temperature of (Tg₁−35)° C. or higher, where Tg₁ is the glass transition temperature of the fluorine resin, and the fluorine resin includes a first fluorine-containing aliphatic ring structure in a molecular chain. The present invention makes it possible to produce a fluorine resin suitable for use in a plastic optical fiber. The first fluorine-containing aliphatic ring structure may have a dioxolane skeleton.

### TECHNICAL FIELD

The present invention relates to a fluorine resin refining method, a method for

producing refined fluorine resin, and a fluorine resin. The invention also relates to an optical material, an electronic material, and a plastic optical fiber each including the fluorine resin.

### BACKGROUND ART

A fluorine resin including a fluorine-containing aliphatic ring structure in a molecular chain is typically amorphous and excellent in transparency, and excellent also in various properties such as liquid repellency, durability, and electrical properties, and thus, such fluorine resins are used in various applications such as optical applications and electronic applications. An example of the optical application is a plastic optical fiber. Non Patent Literature 1 discloses poly (perfluoro-2-methylene-4-methyl-1,3-dioxolane) as a fluorine resin including a fluorine-containing aliphatic ring structure in a molecular chain.

### CITATION LIST

### Non Patent Literature

Non Patent Literature 1: Macromolecules, 2005,38,4237-4245

### SUMMARY OF INVENTION

### Technical Problem

Studies by the present inventors indicate that, in a case where a fluorine resin including a fluorine-containing aliphatic ring structure in a molecular chain is used for a plastic optical fiber, the light transmission loss may be larger than expected from the chemical structure of the fluorine resin.

The present invention aims to provide technology for production of a fluorine resin suitable for use in a plastic optical fiber.

### Solution to Problem

The present invention provides a fluorine resin refining method, including bringing a fluorine resin into contact with a fluorinating agent for refining at a temperature of (Tg₁−35)° C. or higher, where the fluorine resin includes a first fluorine-containing aliphatic ring structure in a molecular chain and Tg₁ is a glass transition temperature of the fluorine resin.

From another aspect, the present invention provides a method for producing a fluorine resin having been refined, the method including refining the fluorine resin by the aforementioned fluorine resin refining methods, and
the fluorine resin includes a first fluorine-containing aliphatic ring structure in a molecular chain.

From another aspect, the present invention provides a fluorine resin having a structural unit including a first fluorine-containing aliphatic ring structure having a dioxolane skeleton,
the fluorine resin having a chemical structure including a second fluorine-containing aliphatic ring structure having a dioxolane skeleton at a terminal of a molecular chain of the fluorine resin, wherein
a terminal group is bonded to a carbon atom at a 2-position of the dioxolane skeleton of the chemical structure, and
I_{F}/I_{H} as a ratio of I_{F} to I_{H} is 7 or more in a mass spectrum of the fluorine resin evaluated by gas chromatography mass spectrometry (GC-MS), where the I_{H} represents an area of a peak derived from the terminal group including a hydrogen atom and the I_{F} represents an area of a peak derived from the terminal group including a fluorine atom.

From another aspect, the present invention provides an optical material including the fluorine resin of the present invention.

From another aspect, the present invention provides an electronic material including the fluorine resin of the present invention.

From another aspect, the present invention provides a plastic optical fiber having a layer including the fluorine resin of the present invention.

### Advantageous Effects of Invention

The present invention can provide technology for production of a fluorine resin suitable for use in a plastic optical fiber.

### BRIEF DESCRIPTION OF DRAWINGS

FIG. 1 is a cross-sectional view schematically showing an example of a plastic optical fiber including a fluorine resin obtained by a fluorine resin refining method according to the present invention.

FIG. 2A shows a mass spectrum of GC-MS for a fluorine resin before refining in Example 1.

FIG. 2B shows a mass spectrum of GC-MS for a fluorine resin after refining in Example 1.

FIG. 3A shows an extracted ion chromatogram of a fluorine resin after refining in Example 1 in a selected ion monitoring (SIM) mode.

FIG. 3B shows an extracted ion chromatogram by SIM of a fluorine resin after refining in Example 1.

FIG. 3C shows an extracted ion chromatogram by SIM of a fluorine resin after refining in Example 1.

### DESCRIPTION OF EMBODIMENTS

A fluorine resin refining method according to the first aspect of the invention includes:
bringing a fluorine resin into contact with a fluorinating agent for refining at a temperature of (Tg₁−35)° C. or higher, where the fluorine resin includes a first fluorine-containing aliphatic ring structure in a molecular chain and Tg₁ is a glass transition temperature of the fluorine resin.

In a second aspect of the present invention, for example, in the refining method according to the first aspect, the fluorine resin in a form of a powder is brought into contact with the fluorinating agent for refining.

In a third aspect of the present invention, for example, in the refining method according to the second aspect, the powder has a median diameter (d50) of 5 to 100 μm.

In a fourth aspect of the present invention, for example, in the refining method according to any one of the first to third aspects, the fluorinating agent is a fluorine gas.

In a fifth aspect of the present invention, for example, in the refining method according to any one of the first to fourth aspects, the fluorine resin is brought into contact with the fluorinating agent for refining at a temperature of (Tg₁−20)° C. or higher.

In a sixth aspect of the present invention, for example, in the refining method according to any one of the first to fifth aspects, the first fluorine-containing aliphatic ring structure has a dioxolane skeleton.

In a seventh aspect of the present invention, for example, in the refining method according to any one of the first to sixth aspects, the fluorine resin has a structural unit (A) represented by the following formula (1):

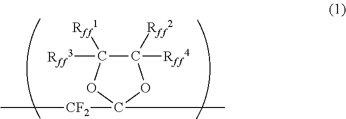

where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² may be linked to form a ring.

In an eighth aspect of the present invention, for example, in the refining method according to the seventh aspect, the structural unit (A) is a unit derived from perfluoro(2-methylene-4-methyl-1,3-dioxolane).

In a ninth aspect of the invention, for example, in the refining method according to any one of the first to eighth aspects, the fluorine resin has a chemical structure including a second fluorine-containing aliphatic ring structure having a dioxolane skeleton at a terminal of a molecular chain of the fluorine resin,
a terminal group is bonded to a carbon atom at a 2-position of the dioxolane skeleton of the chemical structure, and
the fluorine resin is refined so that I_{F}/I_{H} as a ratio of I_{F} to I_{H} is 7 or more in a mass spectrum of the fluorine resin evaluated by gas chromatography mass spectrometry (GC-MS), where the I_{H} represents an area of a peak derived from the terminal group including a hydrogen atom and the I_{F} represents an area of a peak derived from the terminal group including a fluorine atom.

In a tenth aspect of the invention, for example, in the refining method according to the ninth aspect, the chemical structure positioned at the terminal of the molecular chain is a structure represented by the following formula (α):

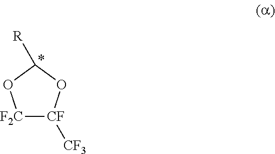

where * indicates an atom bonded to the molecular chain,
the structure of the formula (α) has a terminal group R as the terminal group bonded to the carbon atom at the 2-position of the dioxolane skeleton, and
the fluorine resin is refined so that (I_{F1}+I_{F2})/I_{H1} as a ratio of a sum of I_{F1} and I_{F2} to I_{H1} is 7 or more in the mass spectrum, where the I_{H1} indicates an area of a peak derived from the terminal group R being a hydrogen atom, the I_{F1} indicates an area of a peak derived from the terminal group R being a fluorine atom, and the I_{F2} indicates an area of a peak derived from the terminal group R being a C_{F3} group.

A method according to an eleventh aspect of the present invention is a method for producing a fluorine resin having been refined, the method including refining the fluorine resin by the fluorine resin refining method according to any one of the first to tenth aspects, wherein the fluorine resin includes a first fluorine-containing aliphatic ring structure in a molecular chain.

A fluorine resin according to a twelfth aspect of the present invention is a fluorine resin having a structural unit including a first fluorine-containing aliphatic ring structure having a dioxolane skeleton,
the fluorine resin having a chemical structure including a second fluorine-containing aliphatic ring structure having a dioxolane skeleton at a terminal of a molecular chain of the fluorine resin, wherein
a terminal group is bonded to a carbon atom at a 2-position of the dioxolane skeleton of the chemical structure, and
I_{F}/I_{H} as a ratio of I_{F} to I_{H} is 7 or more in a mass spectrum of the fluorine resin evaluated by gas chromatography mass spectrometry (GC-MS), where the I_{H} represents an area of a peak derived from the terminal group including a hydrogen atom and the I_{F} represents an area of a peak derived from the terminal group including a fluorine atom.

In a thirteenth aspect of the present invention, for example, as to a fluorine resin according to the twelfth aspect,
the chemical structure positioned at the terminal of the molecular chain is a structure represented by the following formula (α):

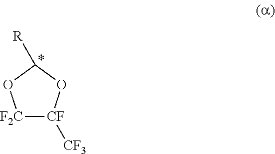

where * indicates an atom bonded to the molecular chain,
the structure of the formula (α) has a terminal group R as the terminal group bonded to the carbon atom at the 2-position of the dioxolane skeleton, and
(I_{F1}+I_{F2})/I_{H1} as a ratio of a sum of I_{F1} and I_{F2} to I_{H1} is 7 or more in the mass spectrum, where the I_{H1} indicates an area of a peak derived from the terminal group R being a hydrogen atom, the I_{F1} indicates an area of a peak derived from the terminal group R being a fluorine atom, and the I_{F2} indicates an area of a peak derived from the terminal group R being a C_{F3} group.

In a fourteenth aspect of the present invention, for example, in the fluorine resin according to the twelfth or thirteenth aspect, the structural unit is a structural unit (A) represented by the following formula (1):

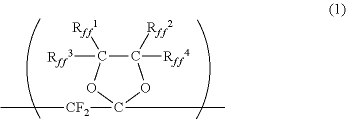

where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² may be linked to form a ring.

An optical material according to a fifteenth aspect of the present invention includes the fluorine resin according to any one of the twelfth to fourteenth aspects.

An electronic material according to a sixteenth aspect of the present invention includes the fluorine resin according to any one of the twelfth to fourteenth aspects.

A plastic optical fiber according to a seventeenth aspect of the present invention, includes the fluorine resin according to any one of the twelfth to fourteenth aspects.

Embodiments of the present disclosure will be described below. The following description is not intended to limit the present invention to any particular embodiment.

### [Fluorine Resin Refining Method]

The refining method of the present embodiment includes refining a fluorine resin including a fluorine-containing aliphatic ring structure (first fluorine-containing aliphatic ring structure) in a molecular chain by bringing the fluorine resin into contact with a fluorinating agent at a temperature of (Tg₁−35)° C. or higher. Tg₁ indicates glass transition temperature of the fluorine resin to be refined. According to the studies by the present inventors, the increase in light transmission loss that may occur in a case of using the fluorine resin for a plastic optical fiber is presumably due to the possible presence of a C—H bond in the fluorine-containing aliphatic ring structure (second fluorine-containing aliphatic ring structure) positioned at a terminal of a molecular chain of the fluorine resin.

(According to the studies by the present inventors, this C—H bond can also be present in a case where a perfluorinated monomer is polymerized alone.) An aliphatic C—H bond usually exhibit absorption at wavelengths that overlap with the wavelength range of a light source used for optical fiber communications. The refining method of the present embodiment is capable of fluorinating the C—H bond, namely, changing the bond to a C—F bond or a C—CF₃bond. A fluorinated bond usually does not exhibit absorption at wavelengths that overlap with the aforementioned wavelength range. Fluorination of the C-H bond can be confirmed, for example, by GC-MS.

A contact with the fluorinating agent may be performed at a temperature of (Tg₁−30)° C. or higher, at a temperature of (Tg₁−25)° C. or higher, at a temperature of (Tg₁−20)° C. or higher, at a temperature of (Tg₁−15)° C. or higher, or even at a temperature of (Tg₁−10)° C. or higher. Further, a contact with the fluorinating agent may be performed at a temperature of (Tg₁+40)° C. or lower, (Tg₁+35)° C. or lower, (Tg₁+30)° C. or lower, (Tg₁+25)° C. or lower, (Tg₁+20)° C. or lower, (Tg₁+15)° C. or lower, or even at a temperature of (Tg₁+10)° C. or lower. The contact can be performed within a temperature range of (Tg₁+30)° C., within a temperature range of (Tg₁+25)° C., or even within a temperature range of (Tg₁+20)° C. The contact at each of the temperatures (refining temperatures) can contribute to a diffusion of the fluorinating agent into the fluorine resin, more specifically, into each molecular chain of the fluorine resin. In addition, in a case where the fluorine resin is a powder, the contact at each of the temperatures (refining temperatures) is particularly suitable for preventing bonding between particles of the powder from binding together. The Tg₁ of fluorine resin is a midpoint glass transition temperature (T_{mg}) determined in accordance with Japanese Industrial Standards K7121:1987.

The Tg₁ of fluorine resin, for example, is in a range of 80° C. to 140° C., and it may be 100° C. or higher, 105° C. or higher, 110° C. or higher, 115° C. or higher, or even 120° C. or higher.

The fluorine resin in a powder form may be brought into contact with the fluorinating agent. The contact of the fluorine resin in a powder form with the fluorinating agent may contribute to a diffusion of the fluorinating agent into each molecular chain of the fluorine resin. The size of the powder, when indicated by its median diameter (d50), may be, for example, 1 mm or less, 800 μm or less, 500 μm or less, 300 μm or less, 100μm or less, 80 μm or less, 60 μm or less, 50 μm or less, or even 40 μm or less. The lower limit of the size of the powder, when indicated by d50, may be, for example, 1 μm or more, 5 μm or more, 10 μm or more, and even 15 μm or more. The d50 of the powder may be in a range of 5 to 100 μm. The d50 of the powder can be evaluated, for example, by a laser diffraction particle size distribution measurement. The shape of the fluorine resin is not limited to a powder, but may be a pellet, for example.

The fluorinating agent is typically a gas. A contact with a gaseous fluorinating agent can contribute to a diffusion of the fluorinating agent into each molecular chain of the fluorine resin. A contact with the gaseous fluorinating agent is also suitable for refining fluorine resin that is difficult to dissolve in a solvent, for example. An example of the gaseous fluorinating agent is a fluorine gas (F₂). The gaseous fluorinating agent may be brought into contact with a fluorine resin, alone or as a mixture with another gas. Examples of the other gas include inert gases such as nitrogen and argon. The fluorine gas may be included in the gas mixture at a proportion of, for example, 5 to 95% by volume, 10 to 90% by volume, 15 to 85% by volume, or even 20 to 80% by volume. The proportion may be 70% or less by volume, 60% or less by volume, 50% or less by volume, 40% or less by volume, or even 30% or less by volume.

The duration for the contact between the fluorine resin and the fluorinating agent (refining time) may be, for example, 5 hours or more, 10 hours or more, 20 hours or more, 30 hours or more, 40 hours or more, 50 hours or more, or even 60 hours or more. The upper limit of the refining time is, for example, 120 hours or less.

In a case where the fluorinating agent is a gas, the pressure of the atmosphere in which the fluorine resin is brought into contact with the fluorinating agent (refining pressure) is, for example, in a range of 10 kPa to 3 MPa when expressed by an absolute pressure (the same hereinafter for pressure). The upper limit of the refining pressure may be 1 MPa or less, 500 kPa or less, 200 kPa or less, or even 100 kPa or less (equal to or lower than the ambient pressure). The refining pressure may be the pressure of the gas mixture.

The fluorine resin can be brought into contact with a fluorinating agent, for example, by introducing the fluorinating agent into a chamber containing the fluorine resin, though the contacting method and embodiment are not limited to the example.

### (Fluorine Resin)

The fluorine resin includes a first fluorine-containing aliphatic ring structure. The first fluorine-containing aliphatic ring structure may be included in the main chain or in a side chain of the fluorine resin. The fluorine resin may have a structural unit including the first fluorine-containing aliphatic ring structure.

An example of the first fluorine-containing aliphatic ring structure has a dioxolane skeleton, though the first fluorine-containing aliphatic ring structure is not limited to the example.

An example of a fluorine resin (polymer (P)) including a first fluorine-containing aliphatic ring structure having a dioxolane skeleton will be described below, though the fluorine resin is not limited to the following example.

The polymer (P) has, for example, a structural unit (A) represented by the following formula (1).

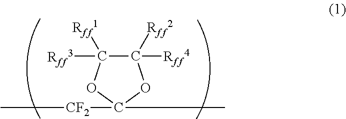

In the formula (1), R_{ff}¹ to R_{ff}⁴ each independently represent a fluorine atom, a perfluoroalkyl group having 1 to 7 carbon atoms, or a perfluoroalkyl ether group having 1to 7 carbon atoms. R_{ff}¹ and R_{ff}² may be linked to form a ring. Here “perfluoro” means that every hydrogen atom bonded to the carbon atom is substituted by a fluorine atom.

In the formula (1), the number of carbon atoms in the perfluoroalkyl group is preferably 1 to 5, more preferably 1 to 3, and even more preferably 1. The perfluoroalkyl group may be linear or branched. Examples of the perfluoroalkyl group include a trifluoromethyl group, a pentafluoroethyl group and a heptafluoropropyl group.

In the formula (1), the number of carbon atoms in the perfluoroalkyl ether group is preferably 1 to 5, and more preferably 1 to 3. The perfluoroalkyl ether group may be linear or branched. An example of the perfluoroalkyl ether group is a perfluoromethoxymethyl group.

In a case where R_{ff}¹ and R_{ff}² are linked to form a ring, the ring may be a five-membered ring or a six-membered ring. Examples of the ring include a perfluorotetrahydrofuran ring, a perfluorocyclopentane ring, and a perfluorocyclohexane ring.

Specific examples of the structural unit (A) are represented by the following formulae (A1) to (A8).

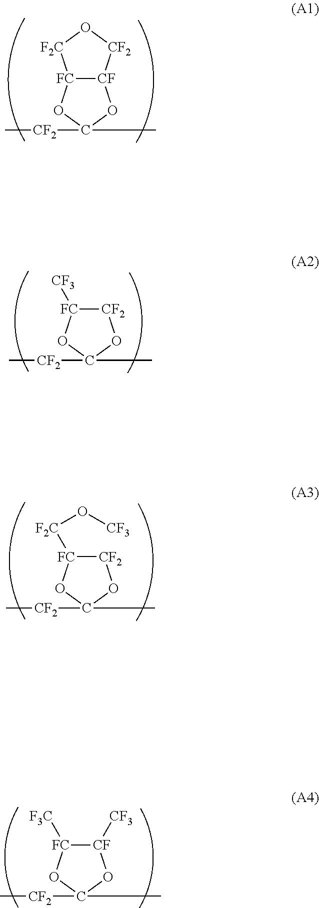

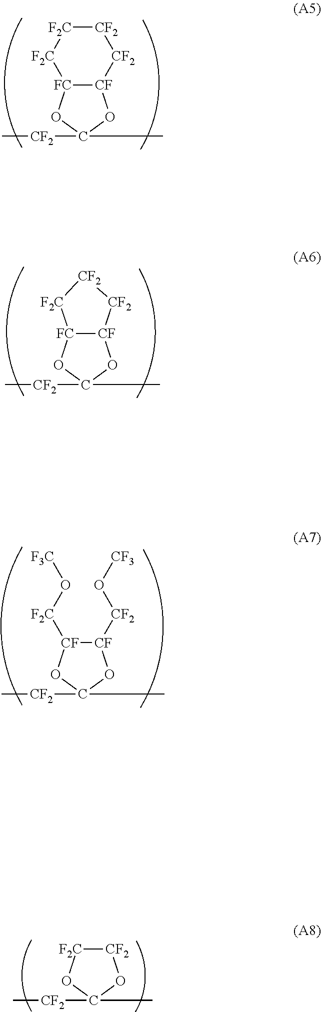

The structural unit (A) may be a structural unit (A2) selected from the structural units represented by the formulae (A1) to (A8), i.e., the structural unit (A) may be a structural unit represented by the following formula (2). The structural unit of the formula (2) is a unit derived from perfluoro (2-methylene-4-methyl-1,3-dioxolane).

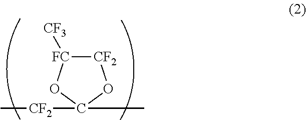

The polymer (P) may include one or more structural units (A). In the polymer (P), the content of the structural unit (A) is preferably 20 mol % or more, and more preferably 40 mol % or more of a total content of all structural units. When including 20 mol % or more of the structural unit (A), the polymer (P) tends to have much higher thermal resistance. When including 40 mol % or more of the structural unit (A), the polymer (P) tends to have much higher transparency and much higher mechanical strength in addition to high thermal resistance. In the polymer (P), the content of the structural unit (A) is preferably 95 mol % or less and more preferably 70 mol % or less of the total of all structural units.

The structural unit (A) is derived, for example, from a compound represented by the following formula (3). In the formula (3), R_{ff}¹ to R_{ff}⁴ are as described for the formula (1). The compound represented by the formula (3) can be obtained by any of the known producing methods, for example, the producing method disclosed in JP 2007-504125 A.

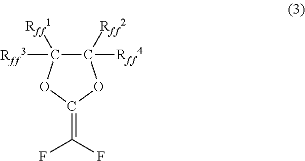

Specific examples of compounds represented by the formula (3) are compounds represented by the following formulae (M1) to (M8).

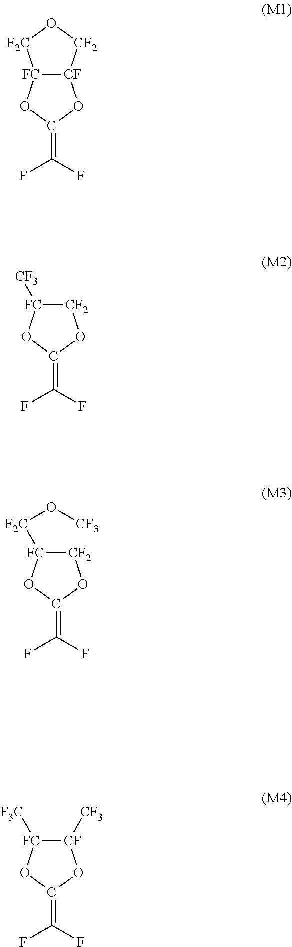

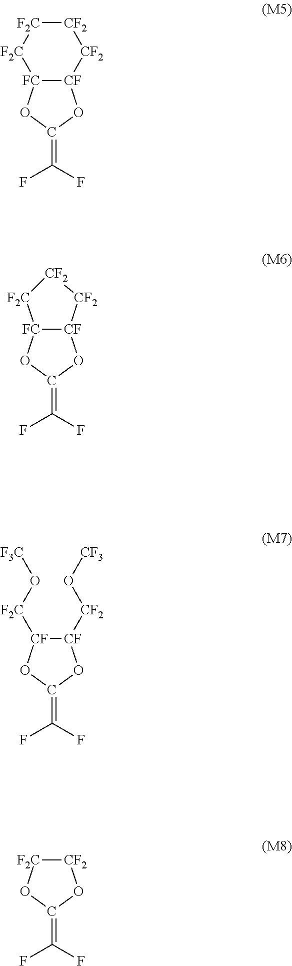

The polymer (P) may further have an additional structural unit other than the structural unit (A). Examples of the additional structural unit include the following structural units (B) to (D).

The structural unit (B) is represented by the following formula (4).

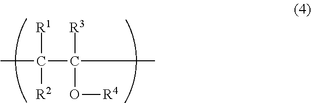

In the formula (4), R¹ to R³ each independently represent a fluorine atom or a perfluoroalkyl group having 1 to 7 carbon atoms. R⁴ represents a perfluoroalkyl group having 1 to 7 carbon atoms. The perfluoroalkyl group may have a ring structure. One or some of the fluorine atoms may be substituted by a halogen atom other than a fluorine atom. One or some of the fluorine atoms in the perfluoroalkyl group may be substituted by a halogen atom other than a fluorine atom.

The polymer (P) may have one or more of structural units (B). In the polymer (P), the content of the structural unit (B) is preferably 5 to 10 mol % of the total of all the structural units. The content of the structural unit (B) may be 9 mol % or less, or 8 mol % or less.

The structural unit (B) is derived from, for example, a compound represented by the following formula (5). In the formula (5), R¹ to R⁴ are as described for the formula (4). The compound represented by the formula (5) is a fluorine-containing vinyl ether such as perfluorovinyl ether.

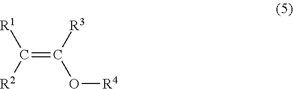

The structural unit (C) is represented by the following formula (6).

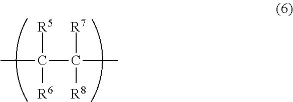

In the formula (6), R⁵ to R⁸ each independently represent a fluorine atom or a perfluoroalkyl group having 1 to 7 carbon atoms. The perfluoroalkyl group may have a ring structure. One or some of the fluorine atoms may be substituted by a halogen atom other than a fluorine atom. One or some of the fluorine atoms in the perfluoroalkyl group may be substituted by a halogen atom other than a fluorine atom.

The polymer (P) may have one or more structural units (C). In the polymer (P), the content of the structural unit (C) is preferably 5 to 10 mol % of the total content of all structural units. The content of the structural unit (C) may be 9 mol % or less, or 8 mol % or less.

The structural unit (C) is derived from, for example, a compound represented by the following formula (7). In the formula (7), R⁵ to R⁸ are as described for the formula (6). The compound represented by the formula (7) is a fluorine-containing olefin such as tetrafluoroethylene or chlorotrifluoroethylene.

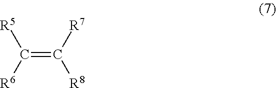

A structural unit (D) is represented by the following formula (8).

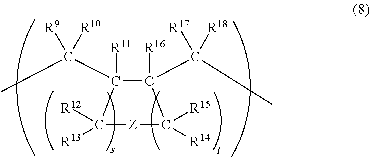

In the formula (8), Z represents an oxygen atom, a single bond, or —OC(R¹⁹R²⁰)O—; and R⁹ to R²⁰ each independently represent a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of the fluorine atoms in the perfluoroalkyl group may be substituted by a halogen atom other than a fluorine atom. One or some of the fluorine atoms in the perfluoroalkoxy group may be substituted by a halogen atom other than a fluorine atom. Symbols s and t are each independently an integer between 0 to 5, and s+t satisfies 1 to 6 (s+t may be 0 in a case where Z is —OC(R¹⁹R²⁰)O—).

The structural unit (D) is preferably represented by the following formula (9). The structural unit represented by the formula (9) is a structural unit represented by the formula (8), where Z is an oxygen atom, s is 0, and t is 2.

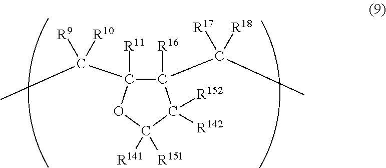

In the formula (9), R¹⁴¹, R¹⁴², R¹⁵¹, and R¹⁵² are each independently a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of the fluorine atoms in the perfluoroalkyl group may be substituted by a halogen atom other than a fluorine atom. One or some of the fluorine atoms in the perfluoroalkoxy group may be substituted by a halogen atom other than a fluorine atom.

The polymer (P) may include one or more structural units (D). In the polymer (P), the content of the structural unit (D) is preferably 30 to 67 mol % of the total of all structural units. The content of the structural unit (D) may be, for example, 35 mol % or more, and may be 60 mol % or less or 55 mol % or less.

The structural unit (D) is derived from, for example, a compound represented by the following formula (10). In the formula (10), Z, R⁹ to R¹⁸, s and t are as described for the formula (8). The compound represented by the formula (10) is a cyclopolymerizable fluorine-containing compound having two or more polymerizable double bonds.

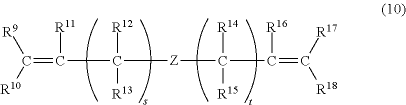

The structural unit (D) is preferably derived from a compound represented by the following formula (11). In the formula (11), R¹⁴¹, R¹⁴², R¹⁵¹, and R¹⁵² are as described for the formula (9).

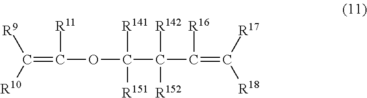

Specific examples of the compounds represented by the formula (10) or the formula (11) include the following compounds.

CF₂=CFOCF₂CF=CF₂

CF₂=CFOCF(CF₃)CF=CF₂

CF₂=CFOCF₂CF₂CF=CF₂

CF₂=CFOCF₂CF(CF₃) CF=CF₂

CF₂=CFOCF(CF₃)CF₂CF=CF₂

CF₂=CFOCFClCF₂CF=CF₂

CF₂=CFOCCl₂CF₂CF=CF₂

CF₂=CFOCF₂OCF=CF₂

CF₂=CFOC(CF₃)₂OCF=CF₂

CF₂=CFOCF₂CF(OCF₃)CF=CF₂

CF₂=CFCF₂CF=CF₂

CF₂=CFCF₂CF₂CF=CF₂

CF₂=CFCF₂OCF₂CF=CF₂

CF₂=CFOCF₂CFClCF=CF₂

CF₂=CFOCF₂CF₂CCI=CF₂

CF₂=CFOCF₂CF₂CF=CFCl

CF₂=CFOCF₂CF (CF₃)CCl=CF₂

CF₂=CFOCF₂OCF=CF₂

CF₂=CFOCCl₂OCF=CF₂

CF₂=CClOCF₂OCCl=CF₂

The polymer (P) may further include an additional structural unit other than the structural units (A) to (D). However, the polymer (P) is preferably substantially free of an additional structural unit other than the structural units (A) to (D). Saying that the polymer (P) is substantially free of an additional structural unit other than the structural units (A) to (D) means that the sum of the amounts of the structural units (A) to (D) is 95 mol % or more and preferably 98 mol % or more of a total content of all structural units in the polymer (P).

The fluorine resin is preferably essentially free of a hydrogen atom. In this Description, “a fluorine resin is essentially free of a hydrogen atom” means that a hydrogen atom content in the fluorine resin is 1 mol % or less.

The fluorine resin can have, at the terminal of its molecular chain, a chemical structure including a second fluorine-containing aliphatic ring structure having a dioxolane skeleton. The second fluorine-containing aliphatic ring structure may be the same as or different from the first fluorine-containing aliphatic ring structure having a dioxolane skeleton. In a case where the fluorine resin is a homopolymer, the second fluorine-containing aliphatic ring structure is usually the same as the first fluorine-containing aliphatic ring structure. The chemical structure may be a structure derived from the compound represented by the formula (3), may be a structure derived from any of the compounds represented by formulae (M1) to (M8), or may be a structure derived from perfluoro(2-methylene-4-methyl-1,3-dioxolane).

It should be noted that the chemical structure that may be provided at the terminal of the molecular chain of the fluorine resin can have a C—H bond in the second fluorine-containing aliphatic ring structure. The degree that the chemical structure has the C—H bond can be evaluated, for example, in a mass spectrum of the fluorine resin evaluated by GC-MS. More specifically, by focusing on the peak of the terminal group bonded to the carbon atom at a 2-position in the dioxolane skeleton in the mass spectrum, the evaluation can be performed based on a ratio of I_{F} to I_{H}, i.e., I_{F}/I_{H}. Here, I_{H} is an area of a peak derived from a terminal group including a hydrogen atom and I_{F} is an area of a peak derived from a terminal group including a fluorine atom. The degree that the chemical structure has the C—H bonds becomes lower when the ratio I_{F}/I_{H} is larger. From this viewpoint, in the refining method of the present embodiment, the fluorine resin may have at a terminal of a molecular chain a terminal group bonded to a carbon atom at a 2-position of a dioxolane skeleton in a chemical structure, and a fluorine resin may be refined so that I_{F}/I_{H} as a ratio of I_{F} to I_{H} will be 7 or more in a mass spectrum of the fluorine resin, where the I_{H} represents an area of a peak derived from the terminal group including a hydrogen atom and the I_{F} represents an area of a peak derived from the terminal group including a fluorine atom. The fluorine resin may be refined so that the ratio I_{F}/I_{H} will be 7.5 or more, 8 or more, 9 or more, 10 or more, 11 or more, 12 or more, or even 13 or more. In a case where there are a plurality of peaks derived from the terminal groups including hydrogen atoms (or fluorine atoms), the sum of the areas of the respective peaks is determined as I_{H} (or I_{F}). The ratio I_{F}/I_{H} varies, for example, depending on the median diameter of fluorine resin, the type and concentration of the fluorinating agent, and the refining conditions (temperature, pressure, duration, or the like).

In a case where the chemical structure that may be provided at the terminal of the molecular chain is a structure represented by the following a formula (α), the structure of the formula (α) has a terminal group R as the terminal group bonded to the carbon atom at the 2-position of the dioxolane skeleton, and the fluorine resin may be refined so that (I_{F1}+I_{F2})/I_{H1} as a ratio of a sum of I_{F1} and I_{F2} to I_{H1} will be 7 or more in the mass spectrum of the fluorine resin, where the I_{H1} indicates an area of a peak derived from the terminal group R being a hydrogen atom, the I_{F1} indicates an area of a peak derived from the terminal group R being a fluorine atom, and the I_{F2} indicates an area of a peak derived from the terminal group R being a CF₃ group. The fluorine resin may be refined so that the ratio (I_{F1}+I_{F2})/I_{H1} will be 7.5 or more, 8 or more, 9 or more, 10 or more, 11 or more, 12 or more, or even 13 or more.

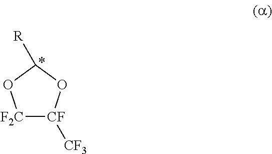

In the formula (a), * indicates an atom bonded to the molecular chain. The bonded atom is a carbon atom at the 2-position of the dioxolane skeleton.

The degree that the chemical structure has the C—H bond will be lower when the ratio I_{F}/I_{H} is larger. Focusing on this fact and from another aspect, the present invention provides a fluorine resin refining method including refining by bringing a fluorine resin into contact with a fluorinating agent, where the fluorine resin includes a first fluorine-containing aliphatic ring structure in its molecular chain, and the fluorine resin has a chemical structure including a second fluorine-containing aliphatic ring structure having a dioxolane skeleton at a terminal of a molecular chain of the fluorine resin. In the method, a terminal group is bonded to a carbon atom at a 2-position of the dioxolane skeleton of the chemical structure, and the fluorine resin is refined so that I_{F}/I_{H} as a ratio of I_{F} to I_{H} will be 7 or more in a mass spectrum of the fluorine resin evaluated by GC-MS, where the I_{H} represents an area of a peak derived from the terminal group including a hydrogen atom and the I_{F} represents an area of a peak derived from the terminal group including a fluorine atom. The fluorine resin may be refined so that the ratio I_{F}/I_{H} will be 7.5 or more, 8 or more, 9 or more, 10 or more, 11 or more, 12 or more, or even 13 or more. The ratio I_{F}/I_{H} varies, for example, depending on the median diameter of the fluorine resin, the type and concentration of the fluorinating agent, and the refining conditions (temperature, pressure, duration, or the like). Examples of these values, types and conditions are described above. In a case where the chemical structure that can be provided at the terminal of the molecular chain is the structure represented by the above formula (α), the structure of the formula (α) has a terminal group R as the terminal group bonded to the carbon atom at the 2-position of the dioxolane skeleton, and the fluorine resin may be refined so that (I_{F1}+I_{F2})/I_{H1} as a ratio of a sum of I_{F1} and I_{F2} to I_{H1} will be 7 or more in the mass spectrum, where the I_{H1} indicates an area of a peak derived from the terminal group R being a hydrogen atom, the I_{F1} indicates an area of a peak derived from the terminal group R being a fluorine atom, and the I_{F2} indicates an area of a peak derived from the terminal group R being a CF₃ group. The fluorine resin may be refined so that the ratio (I_{F1}+I_{F2})/I_{H1} will be 7.5 or more, 8 or more, 9 or more, 10 or more, 11 or more, 12 or more, or even 13 or more.

The fluorine resin can typically be formed by radical polymerization. Known polymerization methods such as solution polymerization, bulk polymerization, and precipitation polymerization can be applied to polymerization of a fluorine resin.

An additive like a polymerization initiator or a chain transfer agent may be used in the polymerization of the fluorine resin. The additive may be a completely fluorinated compound. However, since a completely fluorinated compound tends to be less stable during polymerization, use of a compound including hydrogen atoms may be appropriate, especially in an industrial production of fluorine resin. On the other hand, a compound including hydrogen atoms tends to have double bonds or carboxy groups as a result of the desorption of hydrogen atoms due to heat during the molding of fluorine resins, for example. In other words, the compound tends to cause coloration, foaming, cracks or the like in the resulting resin molded body. Although it is possible to remove the compound by re-precipitation of the fluorine resin before molding, it is difficult to remove a compound like a chain transfer agent, since such compounds are chemically bonded to the molecular chain of the fluorine resin. Focusing on the fact that the chain transfer agent is usually bonded to the terminal of the molecular chains, it is also possible to cleave the bonds by heating. According to the studies by the present inventors, however, sufficient removal is still difficult. In addition, a fluorine resin including the first fluorine-containing aliphatic ring structure having a dioxolane skeleton may be hardly dissolved in a solvent once thermally melted. Sufficient removal of the compound may be even more difficult if the heating temperature is controlled to be lower for avoiding thermal melting. Meanwhile, the refining method of the present embodiment can also contribute to removal of the compound including hydrogen atoms. In other words, the refining method of the present embodiment is suitable also for obtaining a fluorine resin with reduced coloration, foaming, cracking or the like during molding.

Examples of the polymerization initiators include: organic peroxides such as benzoyl peroxide, lauryl peroxide, octanoyl peroxide, acetyl peroxide, di-tert-butyl peroxide, tert-butylcumyl peroxide, dicumyl peroxide, tert-butyl peroxyacetate, perfluoro(di-tert-butylperoxide), bis(2,3,4,5,6-pentafluorobenzoyl) peroxide, tert-butylperoxybenzoate, and tert-butylperpivalate; and azo-based polymerization initiators such as 2,2′-azobis(2,4-dimethylvaleronitrile), 2,2′-azobis(2-butyronitrile), 2,2′-azobisisobutyronitrile, dimethyl-2,2′-azobisisobutylate, and 1,1′-azobis(cyclohexane-1-carbonitrile).

Examples of the completely fluorinated polymerization initiators include perfluoro organic peroxides such as bis(perfluorobenzoyl) peroxide(PFBPO), (CF₃COO)₂, (CF₃CF₂COO)₂, (C₃F—COO)₂, (C₄F₉COO)₂, (C₅F₁₁COO)₂, (C₆F₁₃COO)₂, (C₇F₁₅COO)₂, and (C₈F₁₇COO)₂.

Examples of chain transfer agents include organic compounds having 1 to 20 carbon atoms and including hydrogen atoms and/or chlorine atoms. Specific examples of the chain transfer agents include: organic compounds having 1 to 20 carbon atoms including hydrogen atoms, such as toluene, acetone, ethyl acetate, tetrahydrofuran, methyl ethyl ketone, methanol, ethanol, and isopropanol; and organic compounds having 1 to 20 carbon atoms and including hydrogen atoms and/or chlorine atoms, such as chloroform, dichloromethane, tetrachloromethane, chloromethane, dichloroethane, trichloroethane, tetrachloroethane, pentachloroethane, hexachloroethane, benzylchloride, pentafluorobenzylchloride, and pentafluorobenzoylchloride.

The weight average molecular weight (Mw) of the fluorine resin is, for example, 10,000 to 1,000,000. The Mw can be evaluated by gel permeation chromatography (GPC).

The refining method of the present embodiment may include an additional step. An example of the additional step is a drying step in which the fluorine resin (e.g., powder or pellet) is dried before refining. Drying of the fluorine resin can be performed, for example, by vacuum drying, reduced pressure drying, normal pressure drying, blow drying, shake drying, hot air drying, heating drying, or the like. Another example of the additional step is vacuum devolatilization and/or heating of the fluorine resin after refining so as to remove the remaining fluorinating agent. In one example of the step of heating the fluorine resin after refining (annealing step), the fluorine resin in contact with the fluorinating agent is maintained at a predetermined temperature under an atmosphere of an inert gas such as nitrogen. The annealing step is also suitable for reducing a fluorine-based gas (e.g., F₂ gas, and HF gas) included in the fluorine resin. The temperature for the annealing step may be selected from the range of the above examples as the temperatures at which the fluorine resin and the fluorinating agent are brought into contact with each other. The duration of the annealing step is, for example, 1 to 20 hours. The annealing step can be performed, for example, by discharging the fluorinating agent from the chamber containing the fluorine resin, and then, introducing an inert gas into the chamber. The method and the aspect of the annealing step are not limited to the aforementioned examples.

### [Method for Producing Fluorine Resin]

According to the refining method provided by the present invention, for example, it is possible to provide a refined fluorine resin including a first fluorine-containing aliphatic ring structure in a molecular chain. From this aspect, the method of the present embodiment for producing a fluorine resin is a method for producing a refined fluorine resin, where the fluorine resin includes a first fluorine-containing aliphatic ring structure in a molecular chain, and the producing method includes refining of the fluorine resin by the refining method provided by the present invention.

As to a fluorine resin having a chemical structure including a second fluorine-containing aliphatic ring structure having a dioxolane skeleton at a terminal of a molecular chain, it can be confirmed that the fluorine resin has been refined, for example, by referring to I_{F}/I_{H} as a ratio of an area of a peak in the mass spectrum. The I_{F}/I_{H} of a refined fluorine resin is, for example, 7 or more, and it may be 7.5 or more, 8 or more, 9 or more, 10 or more, 11 or more, 12 or more, or even 13 or more.

Furthermore, in a case where the chemical structure that may be provided at the terminal of the molecular chain of the fluorine resin is the structure represented by the above formula (α), it can be confirmed by referring to (I_{F1}+I_{F2})/I_{H1} that the fluorine resin has been refined. Here, (I_{F1}+I_{F2})/I_{H1} is a ratio of a sum of I_{F1} and I_{F2} to I_{H1}, where the I_{H1} is an area of a peak derived from a terminal group R being a hydrogen atom, the I_{F1} is an area of a peak derived from a terminal group R being a fluorine atom, and the I_{F2} is an area of a peak derived from a terminal group R being a CF₃ group. The ratio (I_{F1}+I_{F2})/I_{H1} of the refined fluorine resin is, for example, 7 or more, and it may be 7.5 or more, 8or more, 9 or more, 10 or more, 11 or more, 12 or more, or even 13 or more.

### [Fluorine Resin]

The fluorine resin of the present embodiment has a structural unit including a first fluorine-containing aliphatic ring structure having a dioxolane skeleton. The fluorine resin has also a chemical structure including a second fluorine-containing aliphatic ring structure having a dioxolane skeleton at a terminal of a molecular chain of the fluorine resin. Further, a terminal group is bonded to a carbon atom at a 2-position of the dioxolane skeleton of the chemical structure, and I_{F}/I_{H} as a ratio of I_{F} to I_{H} is 7 or more in a mass spectrum of the fluorine resin evaluated by GC-MS, where the I_{H} represents an area of a peak derived from the terminal group including a hydrogen atom and the I_{F} represents an area of a peak derived from the terminal group including a fluorine atom. The ratio I_{F}/I_{H} may be 7.5 or more, 8 or more, 9 or more, 10 or more, 11 or more, 12 or more, or even 13 or more. Examples of the first fluorine-containing aliphatic ring structure, the second fluorine-containing aliphatic ring structure and the fluorine resin are as described above in the description of the refining method of the present embodiment.

As to the fluorine resin of the present embodiment, the chemical structure positioned at the terminal of the molecular chain may be a structure represented by the following formula (α). In this case, the structure of the formula (α) has a terminal group R as the terminal group bonded to the carbon atom at the 2-position of the dioxolane skeleton, and (I_{F1}+I_{F2})/I_{H1} as a ratio of a sum of I_{F1} and I_{F2} to I_{H1} may be 7 or more in the mass spectrum, where the I_{H1} indicates an area of a peak derived from the terminal group R being a hydrogen atom, the I_{F1} indicates an area of a peak derived from the terminal group R being a fluorine atom, and the I_{F2} indicates an area of a peak derived from the terminal group R being a CF₃ group. The ratio (I_{F1}+I_{F2})/I_{H1} may be 7.5 or more, 8 or more, 9 or more, 10 or more, 11 or more, 12 or more, or even 13 or more.

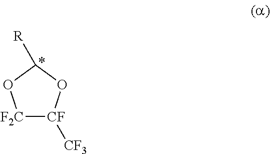

In the formula (a), * indicates an atom bonded to the molecular chain. The bonded atom is a carbon atom at the 2-position of the dioxolane skeleton.

In the fluorine resin of the present embodiment, the structural unit including the first fluorine-containing aliphatic ring structure may be the structural unit (A) represented by the following formula (1).

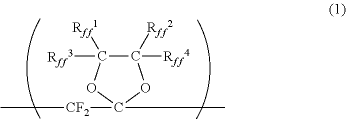

In the formula (1), R_{ff}¹ to R_{ff}⁴ each independently represent a fluorine atom, a perfluoroalkyl group having 1 to 7 carbon atoms, or a perfluoroalkyl ether group having 1to 7 carbon atoms. R_{ff}¹ and R_{ff}² may be linked to form a ring.

The structural unit (A) may be a unit derived from perfluoro(2-methylene-4-methyl-1,3-dioxolane).

The fluorine resin of the present embodiment may have the same structure as the fluorine resin after refining as described above in the description of the refining method of the present embodiment.

The fluorine resin of the present embodiment can be produced, for example, through the refining method provided by the present invention or by the producing method provided by the present invention, though the method for producing the fluorine resin according to the present embodiment is not limited to the examples.

The fluorine resin of the present embodiment can be used, for example, for an optical material or an electronic material. An example of the optical material is plastic optical fiber (POF). The POF can have a layer including the fluorine resin of the present embodiment, though the applications of the fluorine resin of the present embodiment are not limited to the example.

### [POF]

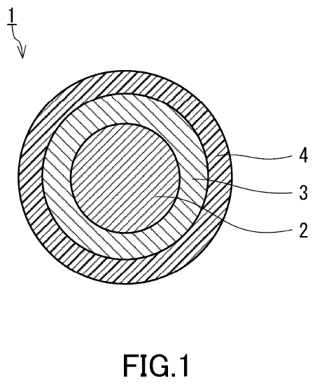

An example of POF including the fluorine resin of the present embodiment is shown in FIG. 1. The POF 1 in FIG. 1 is composed of a plurality of layers including a core 2 and a cladding 3. The core 2 is a layer positioned in the center of the POF 1 and is responsible for transmission of light. The cladding 3 is a layer disposed on an outer surface of the core 2 with respect to the central axis of the POF 1 so as to coat the core 2.

The core 2 has a relatively high refractive index, while the cladding 3 has a relatively low refractive index. The POF 1 in FIG. 1 is further provided with a coating layer (overcladding) 4 that coats the outer circumference of the cladding 3. The POF 1 may be of a gradient index (GI) type.

The fluorine resin of the present embodiment can be included in at least one of

the layers composing the POF 1. The fluorine resin of the present embodiment can be included preferably in the core 2 and the cladding 3, and more preferably, in the core 2. The core 2, the cladding 3 and the coating layer 4 can include a resin that the corresponding layers of known POF may include. Examples of the resin that can be included in the core 2 and the cladding 3 include fluorine-containing resins, acrylic resins such as methyl methacrylate, styrene-based resins, and carbonate-based resins. Examples of the resins that can be included in the coating layer 4 include polycarbonate, engineering plastics, cyclo-olefin polymers, polytetrafluoroethylene (PTFE), modified PTFE, and perfluoroalkoxyalkane (PFA). Each layer may include an additive such as a refractive index modifier.

The POF 1 can be produced, for example, by melt-spinning. In the melt-spinning, the resin as a raw material is melt-extruded to shape each layer for forming the optical fiber.

### EXAMPLES

The present invention will be described in more detail with reference to Examples, though the present invention is not limited to the Examples.

### [Glass Transition Temperature Tg₁]

Tg₁ of the fluorine resin was measured by the method described above under the following conditions.
Measuring equipment: Q-2000 manufactured by TA Instruments
Temperature program: Temperature increase from 30° C. to 200° C. (temperature increase rate: 10° C./minute)
Atmosphere gas: Nitrogen (flow rate: 50 mL/min)
Measuring speed: 10° C./min
Sample volume: 5 mg

### [Terminal Fluorination Rate]

The terminal fluorination rate of the fluorine resin was determined as a peak area ratio (I_{F1}+I_{F2})/I_{H1} in a mass spectrum obtained by performing the following GC-MS with regard to the resin. I_{H1} is an area of a peak (ion mass m/z=195) derived from a hydrogen atom bonded to a carbon atom at a 2-position in a dioxolane skeleton in the second fluorine-containing aliphatic ring structure positioned at a terminal of a molecular chain. I_{F1} is an area of a peak (ion mass m/z=213) derived from a fluorine atom bonded to the carbon atom at the 2-position. IF2 is an area of a peak (ion mass m/z=263) derived from a CF3 group bonded to the carbon atom at the 2-position.

### [GC-MS]

The GC-MS with respect to the fluorine resin was performed under the following conditions.
Thermal desorption system: TDS/CIS manufactured by GERSTEL GmbH & Co.KG
GC/MS instrument: 6980plus/5973N manufactured by Agilent Technologies
GC column: HP-5 ms UI manufacture by Agilent Technologies, 30m×0.25 mm, id×0.25 μm
Sample volume: 10 mg (contained in a glass tube)
Sample heating conditions: Temperature increase from 20° C. to 270° C. (rate: 60° C./minute) and maintained for 30 minutes
Others: A gas generated by the sample heating was cold trapped for a total component analysis. Measurements were performed in a scan mode and in a selected ion monitoring (SIM) mode.

### [Heating Test]

A heating test of a fluorine resin assuming a mold processing was performed as follows. Fluorine resin (10 g) to be evaluated was introduced into a PFA tube with an inner diameter of 10 mm, one side of the tube being sealed with a PTFE stopper. Next, the fluorine resin in the tube was heated at 270° C. for 20 hours to melt, and then, allowed to cool to room temperature, thereby forming a rod. After the cooling, the rod was taken out to be observed under an optical microscope (magnification: 10 to 20×) to check for cracks and foaming present in the field of view of the microscope. The observations were made at randomly-selected 10 sites.

### Example 1

A powder (1 kg) of poly (perfluoro (2-methylene-4-methyl-1,3-dioxolane), namely PFMMD was placed spread in a PFA tray (internal dimensions: length of 287 mm, width of 382 mm, depth of 48 mm) evenly in depth and housed in a chamber. The median diameter (d50) of the powder evaluated by a laser diffraction particle size distribution measurement was 30 μm. The PFMMD had Tg of 131° C. Next, the gas in the chamber was replaced by a nitrogen gas several times to create a nitrogen gas atmosphere, and then, the temperature was raised to 130° C. At the time the temperature reached 130° C., the pressure inside the chamber was set to 90 kPa while a mixture of fluorine gas/nitrogen gas (20:80 by volume) as a fluorinating agent was poured into the chamber (flow rate: 10.50 L/min). After maintaining the treatment conditions of 130° C. and 90 kPa for approximately 65 hours, the gas in the chamber was replaced by nitrogen to stop the exposure of the PFMMD to the fluorinating agent, and the chamber was cooled to room temperature to complete refining of the PFMMD.

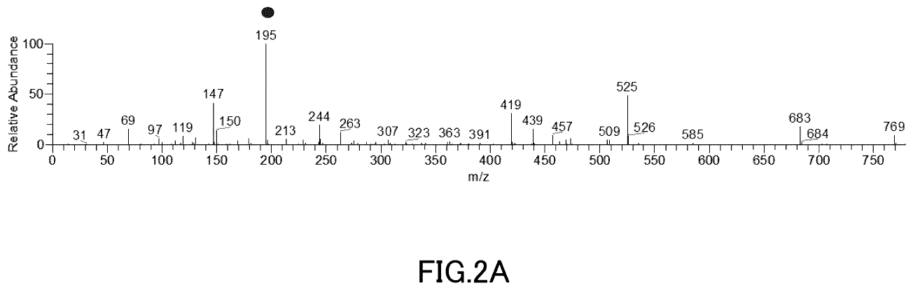

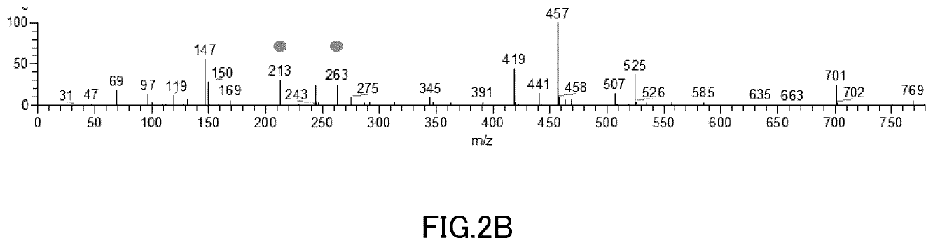

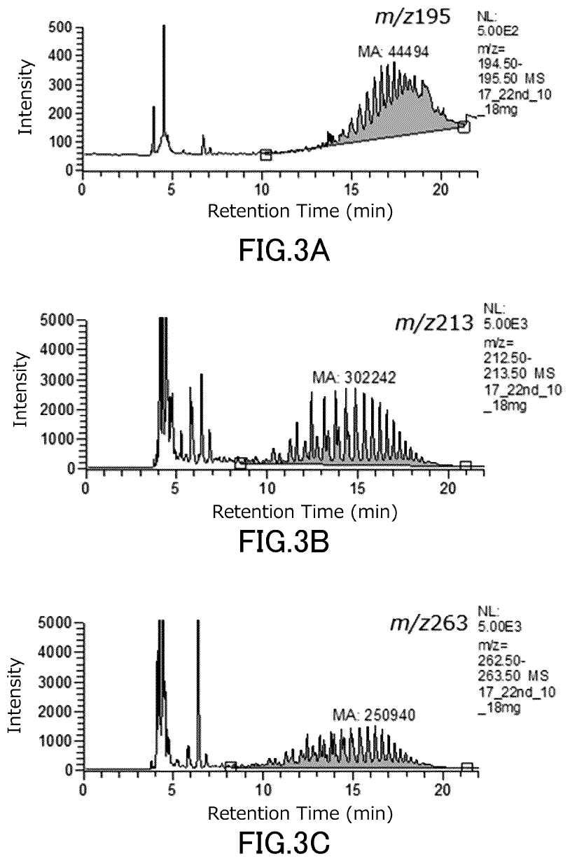

FIG. 2A and FIG. 2B show the mass spectra of PFMMD before and after the refining, respectively. As shown in FIG. 2A and FIG. 2B, the peak area I_{H1} was considerably decreased by the refining. FIG. 3A, FIG. 3B, and FIG. 3C show extracted ion chromatograms in the selected ion monitoring (SIM) mode for the PFMMD after the refining. The spectral peak in each of FIG. 3A, FIG. 3B and FIG. 3C was integrated to obtain the area corresponding to the fragment ion of each terminal group R. After the refining, I_{H1} was 44494, I_{F1} was 302242, I_{F2} was 250940, and the ratio (I_{F1}+I_{F2})/I_{H1} was 12.4. No cracks or foaming were observed in the formed rod.

### Example 2

Refining of the PFMMD was completed in the same manner as in Example 1, except that the fluorinating agent was replaced by a simple fluorine gas. The ratio (I_{F1}+I_{F2})/I_{H1} of the PFMMD after the refining was 13.4. No cracks or foaming were observed in the formed rod.

### Example 3

Refining of the PFMMD was completed in the same manner as in Example 1, except that the duration for exposing the PFMMD to the fluorinating agent was changed to 30 hours. The ratio (I_{F1}+I_{F2})/I_{H1} of the PFMMD after the refining was 13.1. No cracks or foaming were observed in the formed rod.

### Example 4

Refining of the PFMMD was completed in the same manner as in Example 1, except that the duration for exposing the PFMMD to the fluorinating agent was changed to 90 hours. The ratio (I_{F1}+I_{F2})/I_{H1} of the PFMMD after the refining was 13.1. No cracks or foaming were observed in the formed rod.

### Example 5

Refining of the PFMMD was completed in the same manner as in Example 1, except that the duration for exposing the PFMMD to the fluorinating agent was changed to 5 hours. The ratio (I_{F1}+I_{F2})/I_{H1} of the PFMMD after the refining was 7.2. Slight cracks and slight foaming were observed in the formed rod.

### Example 6

Refining of the PFMMD was completed in the same manner as in Example 1, except that the temperature for exposing the PFMMD to the fluorinating agent was changed to 100° C. The ratio (I_{F1}+I_{F2})/I_{H1} of the PFMMD after the refining was 7.0.Slight cracks and slight foaming were observed in the formed rod.

### Example 7

Refining of the PFMMD was completed in the same manner as in Example 1, except that the temperature for exposing the PFMMD to the fluorinating agent was changed to 100° C. and that pellet-shaped PFMMMD of a 1 cm square with a thickness of 2 mm was used in place of a powder. The ratio (I_{F1}+I_{F2})/I_{H1} of the PFMMD after the refining was 8.0. Slight cracks and slight foaming were observed in the formed rod.

### Example 8

Refining of the PFMMD was completed in the same manner as in Example 1, except that pellet-shaped PFMMMD of a 1 cm square with a thickness of 2 mm was used in place of a powder. The ratio (I_{F1}+I_{F2})/I_{H1} of the PFMMD after the refining was 13.0. No cracks or foaming were observed in the formed rod.

### Example 9

Refining of the PFMMD was completed in the same manner as in Example 1, except that the temperature for exposing the PFMMD to the fluorinating agent was changed to 160° C. The ratio (I_{F1}+I_{F2})/I_{H1} of the PFMMD after the refining was 14.0.No cracks or foaming were observed in the formed rod.

### Example 10

Refining of the PFMMD was completed in the same manner as in Example 1,except that the temperature for exposing the PFMMD to the fluorinating agent was changed to 160° C. and that pellet-shaped PFMMMD of a 1 cm square with a thickness of 2 mm was used in place of the powder. The ratio (I_{F1}+I_{F2})/I_{H1} of the PFMMD after the refining was 12.0. No cracks or foaming were observed in the formed rod.

### Comparative Example 1

In an evaluation of an unrefined PFMMD, the ratio (I_{F1}+I_{F2})/I_{H1} was 0.1. In a rod formed by the aforementioned method using the unrefined PFMMD, considerable cracks and foaming were observed.

The refining conditions and evaluation results are summarized in Table 1 below.

TABLE 1

| | | Example | | | | | |
|---|---|---|---|---|---|---|---|
| | | 1 | 2 | 3 | 4 | 5 | 6 |
| Refining | Fluorine gas | 20 | 100 | 20 | 20 | 20 | 20 |
| condition | concentration | | | | | | |
| | (vol %) | | | | | | |
| | Exposure duration | 65 | 65 | 30 | 90 | 5 | 65 |
| | (hour) | | | | | | |
| | Temperature (° C.) | 130 | 130 | 130 | 130 | 130 | 100 |
| Resin form | | Powder | Powder | Powder | Powder | Powder | Powder |
| Evaluation | Ratio (I_{F1} + I_{F2})/I_{H1} | 12.4 | 13.4 | 13.1 | 13.1 | 7.2 | 7.0 |
| | Cracks | None | None | None | None | Slightly | Slightly |
| | Foaming | None | None | None | None | Slightly | Slightly |

| | | Example | | | | Comparative |
|---|---|---|---|---|---|---|
| | | 7 | 8 | 9 | 10 | Example 1 |
| Refining | Fluorine gas | 20 | 20 | 20 | 20 | — |
| condition | concentration | | | | | |
| | (vol %) | | | | | |
| | Exposure duration | 65 | 65 | 65 | 65 | — |
| | (hour) | | | | | |
| | Temperature (° C.) | 100 | 130 | 160 | 160 | — |
| Resin form | | Pellet | Pellet | Powder | Pellet | Powder |
| Evaluation | Ratio (I_{F1} + I_{F2})/I_{H1} | 8.0 | 13.0 | 14.0 | 12.0 | 0.1 |
| | Cracks | Slightly | None | None | None | Considerable |
| | Foaming | Slightly | None | None | None | Considerable |

### INDUSTRIAL APPLICABILITY

The fluorine resins obtained through the refining method of the present invention may be used, for example, in optical materials and electronic materials. An example of the optical materials is POF.

1. A fluorine resin refining method, comprising bringing a fluorine resin into contact with a fluorinating agent for refining at a temperature of (Tg₁−35)° C. or higher, where the fluorine resin comprises a first fluorine-containing aliphatic ring structure in a molecular chain and Tg₁ is a glass transition temperature of the fluorine resin.

2. The fluorine resin refining method according to claim 1, wherein the fluorine resin in a form of a powder is brought into contact with the fluorinating agent for refining.

3. The fluorine resin refining method according to claim 2, wherein the powder has a median diameter (d50) of 5 to 100 μm.

4. The fluorine resin refining method according to claim 1, wherein the fluorinating agent is a fluorine gas.

5. The fluorine resin refining method according to claim 1, wherein the fluorine resin is brought into contact with the fluorinating agent for refining at a temperature of (Tg₁−20)° C. or higher.

6. The fluorine resin refining method according to claim 1, wherein the first fluorine-containing aliphatic ring structure has a dioxolane skeleton.

7. The fluorine resin refining method according to claim 1, wherein the fluorine resin has a structural unit (A) represented by the following formula (1): 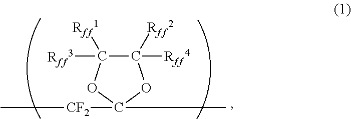
where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{f}² are linkable to form a ring.

8. The fluorine resin refining method according to claim 7, wherein the structural unit (A) is a unit derived from perfluoro(2-methylene-4-methyl-1,3-dioxolane).

9. The fluorine resin refining method according to claim 1, wherein
the fluorine resin has a chemical structure comprising a second fluorine-containing aliphatic ring structure having a dioxolane skeleton at a terminal of a molecular chain of the fluorine resin,
a terminal group is bonded to a carbon atom at a 2-position of the dioxolane skeleton of the chemical structure, and the fluorine resin is refined so that I_{F}/I_{H} as a ratio of I_{F} to I_{H} is 7 or more in a mass spectrum
of the fluorine resin evaluated by gas chromatography mass spectrometry (GC-MS), where the I_{H} represents an area of a peak derived from the terminal group comprising a hydrogen atom and the I_{F} represents an area of a peak derived from the terminal group comprising a fluorine atom.

10. The fluorine resin refining method according to claim 9, wherein the chemical structure positioned at the terminal of the molecular chain is a structure represented by the following a formula (α): 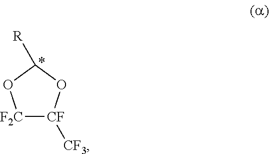
where * indicates an atom bonded to the molecular chain,
the structure of the formula (α) has a terminal group R as the terminal group bonded to the carbon atom at the 2-position of the dioxolane skeleton, and
the fluorine resin is refined so that (I_{F1}+I_{F2})/I_{H1} as a ratio of a sum of I_{F1} and I_{F2} to I_{H1} is 7 or more in the mass spectrum, where the I_{H1} indicates an area of a peak derived from the terminal group R being a hydrogen atom, the I_{F1} indicates an area of a peak derived from the terminal group R being a fluorine atom, and the I_{F2} indicates an area of a peak derived from the terminal group R being a CF₃ group.

11. A method for producing a fluorine resin having been refined, the method comprising refining the fluorine resin by the fluorine resin refining method according to claim 1, wherein
the fluorine resin comprises a first fluorine-containing aliphatic ring structure in a molecular chain.

12. A fluorine resin having a structural unit comprising a first fluorine-containing aliphatic ring structure having a dioxolane skeleton,
the fluorine resin having a chemical structure comprising a second fluorine-containing aliphatic ring structure having a dioxolane skeleton at a terminal of a molecular chain of the fluorine resin, wherein
a terminal group is bonded to a carbon atom at a 2-position of the dioxolane skeleton of the chemical structure, and
I_{F}/I_{H} as a ratio of I_{F} to I_{H} is 7 or more in a mass spectrum of the fluorine resin evaluated by gas chromatography mass spectrometry (GC-MS), where the I_{H} represents an area of a peak derived from the terminal group comprising a hydrogen atom and the I_{F} represents an area of a peak derived from the terminal group comprising a fluorine atom.

13. The fluorine resin according to claim 12, wherein
the chemical structure positioned at the terminal of the molecular chain is a structure represented by the following formula (α): 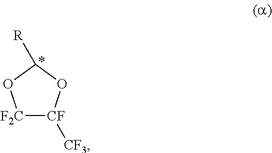
where * indicates an atom bonded to the molecular chain,
the structure of the formula (α) has a terminal group R as the terminal group bonded to the carbon atom at the 2-position of the dioxolane skeleton, and (I_{F1}+I_{F2})/I_{H1} as a ratio of a sum of I_{F1} and I_{F2} to I_{H1} is 7 or more in the mass spectrum, where the I_{H1} indicates an area of a peak derived from the terminal group R being a hydrogen atom, the I_{F1} indicates an area of a peak derived from the terminal group R being a fluorine atom, and the I_{F2} indicates an area of a peak derived from the terminal group R being a CF₃ group.

14. The fluorine resin according to claim 12, wherein the structural unit is a structural unit (A) represented by the following formula (1): 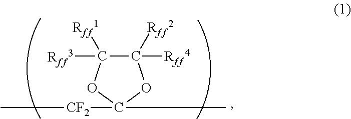
where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² are linkable to form a ring.

15. An optical material comprising the fluorine resin according to claim 12.

16. An electronic material comprising the fluorine resin according to claim 12.

17. A plastic optical fiber comprising a layer comprising the fluorine resin according to claim 12.
